(19) United States
(12) Patent Application Publication
(10) Pub. No.: US 2012/0169599 A1
(43) Pub. Date: Jul. 5, 2012

(54) WIRELESS MOUSE

(75) Inventors: CHUN-XIAO WU, Shenzhen City (CN); YAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/012,823

(22) Filed: Jan. 25, 2011

(30) Foreign Application Priority Data
Dec. 31, 2010 (CN) 201010617415.5

(51) Int. Cl. G06F 3/033

(52) U.S. Cl. 345/163

(57) ABSTRACT

A wireless mouse includes a case, a mouse circuit received in the case, and a battery control circuit to power the mouse circuit. The battery control circuit includes a battery, a touch switch positioned on the case, and a switch circuit connected to the battery, the touch switch, and the mouse circuit. When the touch switch is touched, the touch switch is turned on, the switch circuit outputs a high level signal to the mouse circuit. When the touch switch is not touched, the touch switch is turned off, the switch circuit outputs a low level signal to the mouse circuit.

### BACKGROUND

1. Technical Field

The present disclosure relates to wireless mice, and particularly to a wireless mouse with power saving function.

2. Description of Related Art

A wireless mouse communicates with a computer system by means of electromagnetic signals. Since no cable is connected to the computer system, the wireless mouse has to incorporate an independent power source, such as a battery. However, the battery must be replaced or recharged based on usage. Therefore, saving power becomes an important issue for the wireless mouse.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of a wireless mouse in accordance with an embodiment, the wireless mouse including a battery control circuit.

FIG. 2 is a circuit diagram of the battery control circuit of the wireless mouse of FIG. 1, in accordance with a first embodiment.

FIG. 3 is a circuit diagram of the battery control circuit of the wireless mouse of FIG. 1, in accordance with a second embodiment.

FIG. 4 is a circuit diagram of the battery control circuit of the wireless mouse of FIG. 1, in accordance with a third embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

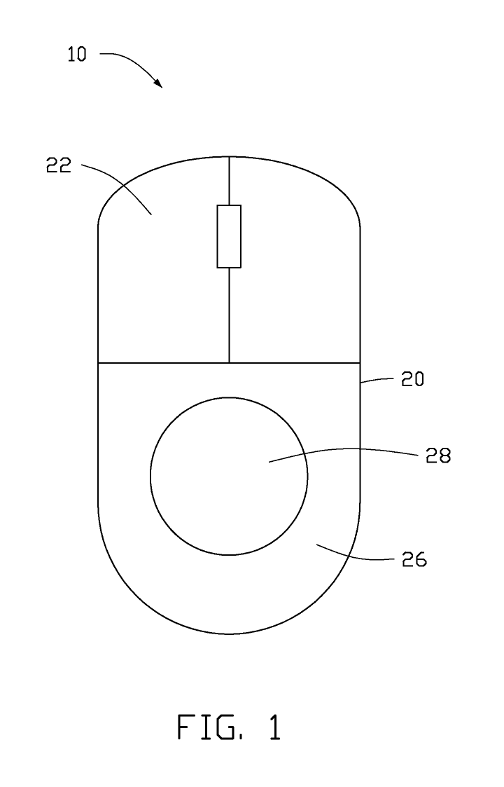

Referring to FIG. 1, an embodiment of a wireless mouse 10 includes a case 20, a mouse circuit received in the case 20, and a battery control circuit to power the mouse circuit. The case 20 includes a plurality of mouse buttons 22 and a palm rest 26. A touch switch 28 is positioned on the palm rest 26.

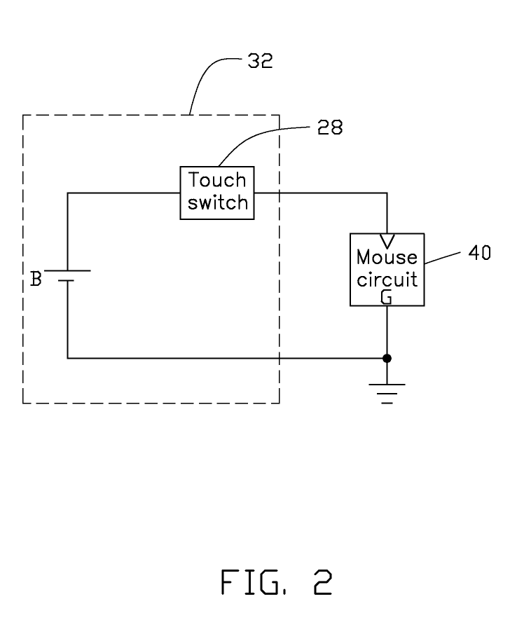

Referring to FIG. 2, a first embodiment of the battery control circuit 32 of the wireless mouse 10 includes a battery B and the touch switch 28. A positive terminal of the battery B is connected to a power pin V of the mouse circuit 40 via the touch switch 28. A negative terminal of the battery B and a ground pin G of the mouse circuit 40 are grounded. It may be understood that the touch switch 28 may be a capacitance touch switch and a resistance touch switch, which only have to be touched by an object to operate. The capacitance touch switch and the resistance touch switch fall within well-known technologies, and are therefore not described here.

The mouse circuit 40 is used to perform basic function of the wireless mouse 10. For example, the mouse circuit 40 is used to receive operation signals from the mouse buttons 22, and transmit the operation signals to a corresponding computer system (not shown). It may be understood that the mouse circuit 40 falls within well-known technologies, and is therefore not described here.

In use, a palm is placed on the palm rest 26, and touches the touch switch 28. The touch switch 28 is turned on, the battery B supplies power to the mouse circuit 40 via the touch switch 28, and the mouse circuit 40 begins to work.

When the wireless mouse 10 is not in use, the palm does not touch the touch switch 28. The touch switch 28 is turned off, there is no power supplied to the mouse circuit 40, and the mouse circuit 40 does not work.

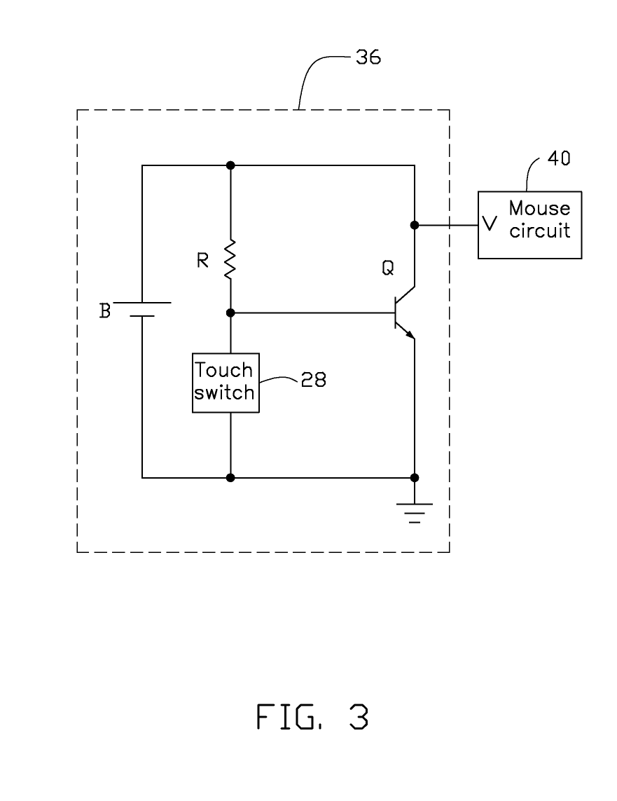

Referring to FIG. 3, a second embodiment of the battery control circuit 36 of the wireless mouse 10 includes the battery B, the touch switch 28, an electronic switch Q functioning as a switch circuit, and a resistor R. A first terminal of the electronic switch Q is connected to the positive terminal of the battery B via the resistor R, and is connected to the negative terminal of the battery B via the touch switch 28. A second terminal of the electronic switch Q is connected to the positive terminal of the battery B, and is connected to the power pin V of the mouse circuit 40 to supply power to the mouse circuit 40. A third terminal of the electronic switch Q and the negative terminal of the battery B are grounded. In present embodiment, the electronic switch Q is an NPN transistor, the first, second, and third terminals of the electronic switch Q are a base, a collector, and an emitter respectively. In other embodiments, the electronic switches Q may be an n-channel metal-oxide-semiconductor field-effect transistor, or other switches having similar functions.

In use, the palm is placed on the palm rest 26, and touches the touch switch 28. The touch switch 28 is turned on, the electronic switches Q is turned off, the second terminal of the electronic switch Q outputs a high level signal to the mouse circuit 40, and the mouse circuit 40 begins to work.

When the wireless mouse 10 is not in use, the palm does not touch the touch switch 28. The touch switch 28 is turned off, the electronic switches Q is turned on, the second terminal of the electronic switch Q outputs a low level signal to the mouse circuit, and the mouse circuit does not work.

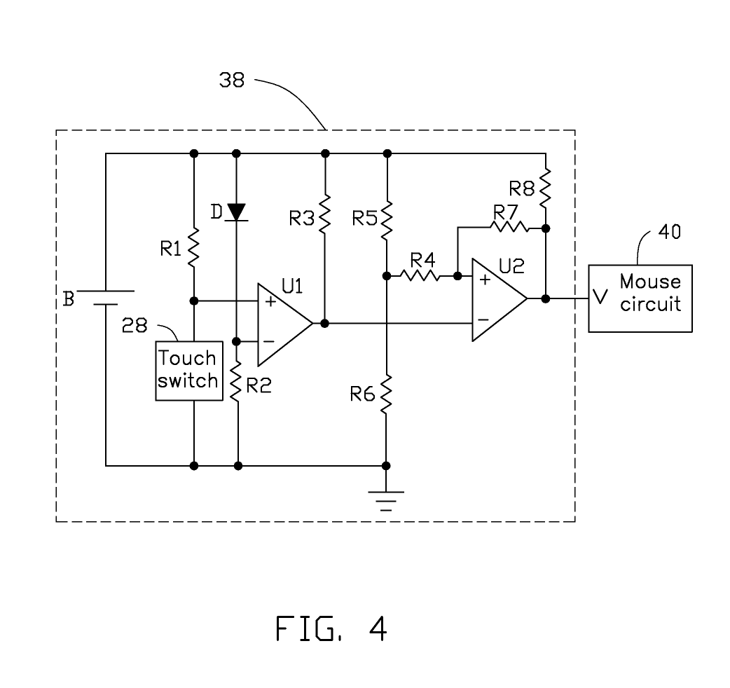

Referring to FIG. 4, a third embodiment of the battery control circuit 38 of the wireless mouse 10 includes the battery B, the touch switch 28, a diode D, two comparators U1 and U2 to form a switch circuit, and eight resistors R1-R8. A positive input of the comparator U1 is connected to the positive terminal of the battery B via the resistor R1, and is connected to the negative terminal of the battery B via the touch switch 28. A negative input of the comparator U1 is connected to a cathode of the diode D, and is connected to the negative terminal of the battery B via the resistor R2. An anode of the diode D is connected to the positive terminal of the battery B. An output of the comparator U1 is connected to the positive terminal of the battery B via the resistor R3. A positive input of the comparator U2 is connected to the positive terminal of the battery B via the resistors R4 and R5 sequentially, and is connected to the negative terminal of the battery B via the resistors R4 and R6 sequentially. A negative input of the comparator U2 is connected to the output of the comparator U1. An output of the comparator U2 is connected to the positive input of the comparator U2 via the resistor R7, as well is connected to the positive terminal of the battery B via the resistor R8, and is connected to a power pin V of the mouse circuit 40 to supply power to the mouse circuit 40. The negative terminal of the battery B is grounded. In other embodiments, the resistors R4 and R7 can be omitted according to actual need.

In use, the palm is placed on the palm rest 26, and touches the touch switch 28. The touch switch 28 is turned on, the positive input of the comparator U1 is grounded via the touch switch 28, and voltage at the positive input of the comparator U1 approximates to zero. The output of the comparator U1 outputs a low level signal to the negative input of the comparator U2, the output of the comparator U2 outputs a high level signal to the mouse circuit 40, and the mouse circuit 40 begins to work.

When the wireless mouse 10 is not in use, the palm does not touch the touch switch 28. The touch switch 28 is turned off, voltage at the positive input of the comparator U1 equals to voltage at the positive terminal of the battery B. The output of the comparator U1 outputs a high level signal to the negative input of the comparator U2, the output of the comparator U2 outputs a low level signal to the mouse circuit 40, and the mouse circuit 40 does not work.

As detailed above, according to employing the battery control circuit, the wireless mouse 10 is conveniently controlled to power on or to power off the mouse circuit 40 to save power.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A wireless mouse comprising:
a case;
a touch switch positioned on the case;
a mouse circuit received in the case to perform basic function of the wireless mouse; and
a battery comprising a positive terminal connected to the mouse circuit via the touch switch, and a negative terminal grounded;
wherein when the touch switch is touched, the touch switch is turned on, the battery supplies power to the mouse circuit; and
wherein when the touch switch is not touched, the touch switch is turned off, the battery does not supply power to the mouse circuit.

2. The wireless mouse of claim 1, wherein the case includes a plurality of mouse buttons and a palm rest, the touch switch is positioned on the palm rest.

3. The wireless mouse of claim 1, wherein the touch switch is a capacitance touch switch.

4. The wireless mouse of claim 1, wherein the touch switch is a resistance touch switch.

5. A wireless mouse comprising:
a case;
a mouse circuit received in the case to perform basic function of the wireless mouse; and
a battery control circuit to power the mouse circuit, the battery control circuit comprising:
a battery;
a touch switch positioned on the case; and
a switch circuit connected to the battery, the touch switch, and the mouse circuit;
wherein when the touch switch is touched, the touch switch is turned on, the switch circuit outputs a high level signal to the mouse circuit; and
wherein when the touch switch is not touched, the touch switch is turned off, the switch circuit outputs a low level signal to the mouse circuit.

6. The wireless mouse of claim 5, wherein the case includes a plurality of mouse buttons and a palm rest, the touch switch is positioned on the palm rest.

7. The wireless mouse of claim 5, wherein the touch switch is a capacitance touch switch.

8. The wireless mouse of claim 5, wherein the touch switch is a resistance touch switch.

9. The wireless mouse of claim 5, wherein the switch circuit comprises an electronic switch comprising a first terminal connected to a positive terminal of the battery via a resistor and connected to a negative terminal of the battery via the touch switch, a second terminal connected to the positive terminal of the battery and connected to the mouse circuit; and a third terminal connected to the negative terminal of the battery;
wherein when the touch switch is touched, the touch switch is turned on, the electronic switch is turned off, the second terminal of the electronic switch outputs a high level signal to the mouse circuit; and
wherein when the touch switch is not touched, the touch switch is turned off, the electronic switch is turned on, the second terminal of the electronic switch outputs a low level signal to the mouse circuit.

10. The wireless mouse of claim 9, wherein the electronic switch is an NPN transistor, the first, second, and third terminals of the electronic switch are a base, a collector, and an emitter respectively.

11. The wireless mouse of claim 5, wherein the switch circuit comprises:
a first comparator comprising a positive input connected to a positive terminal of the battery via a first resistor and connected to a negative terminal of the battery via the touch switch, an negative input connected to a cathode of a diode and connected to the negative terminal of the battery via a second resistor, and an output connected to the positive terminal of the battery via a third resistor, wherein an anode of the diode is connected to the positive terminal of the battery; and
a second comparator comprising a positive input connected to the positive terminal of the battery via a fourth resistor and connected to the negative terminal of the battery though a fifth resistor, an negative input connected to the output of the first comparator, and an output connected to the mouse circuit and connected to the positive terminal of the battery though a sixth resistor;
wherein when the touch switch is touched, the touch switch is turned on, the output of the first comparator outputs a low level signal to the negative input of the second comparator, the output of the second comparator outputs a high level signal to the mouse circuit; and
wherein when the touch switch is not touched, the touch switch is turned off, the output of the first comparator outputs a high level signal to the negative input of the second comparator, the output of the second comparator outputs a low level signal to the mouse circuit.

12. The wireless mouse of claim 11, wherein the positive input of the second comparator is connected to the positive terminal of the battery via a seventh resistor and the fourth resistor sequentially, connected to the negative terminal of the battery via the seventh resistor and the fifth resistor sequentially, and connected to the output of the second comparator via an eighth resistor.
